(19) United States
(12) Patent Application Publication
(10) Pub. No.: US 2020/0278810 A1
(43) Pub. Date: Sep. 3, 2020

(54) Method for Mitigating Writing-Performance Variation and Preventing IO Blocking in a Solid-State Drive

(71) Applicants: Goke Taiwan Research Laboratory Ltd., Taipei City (TW); Xinsheng Intelligent Technology Co., Ltd., JIANGSU (CN)

(72) Inventors: Po-Chien Chang, Taipei City (TW); Yen-Lan Hsu, Taipei City (TW); Kun-Lung Hsieh, Taipei City (TW)

(21) Appl. No.: 16/289,739

(22) Filed: Mar. 1, 2019

(51) Int. Cl. G06F 3/06

(52) U.S. Cl. CPC G06F 3/0659; G06F 3/061; G06F 3/0652; G06F 3/064; G06F 3/0653; G06F 3/0673

(57) ABSTRACT

A method for mitigating writing performance variation comprises the steps of receiving a request, determining whether status of a SSD is normal or constrained, fulfilling the request if the status is normal, inserting the request in a queue if the status is constrained, monitoring a first request in the queue and calculating expected time of waiting, determining whether elapsed time of the first request is shorter than the expected time of waiting, waiting for some time before returning to the step of monitoring the first request and calculating the expected time of waiting if the elapsed time is shorter than the expected time of waiting, fulfilling and removing the first request from the queue if the elapsed time is not shorter than the expected time of waiting, determining whether the queue is empty, returning to the step of waiting if the queue is not empty.

### BACKGROUND OF INVENTION

### 1. Field of Invention

The present invention relates to a solid-state drive and, more particularly, to a method for mitigating writing-performance variation and preventing IO blocking in a solid-state drive.

### 2. Related Prior Art

A solid-state drive runs firmware to execute system tasks and/or read/write system data. The system tasks and/or reading/writing inevitably reduce writing performance. Such variation of the writing performance is not desirable. IO blocking is also not desirable. “IO blocking” is a situation where the input/output per second is zero, i.e., the system appears to be non-responsive. The primary reason for a low or zero IOPS is that garbage collection occupies most of the bandwidth of a flash memory of the solid-state drive. A method for preventing a low or zero IOPS is to delay the garbage collection. However, such delayed garbage collection could cause inadequate storing capacity of the solid-state drive. Another method for preventing a low or zero IOPS is to provide the solid-state drive with several cores. One of the cores is used to read/write. The other core is used to execute garbage collection. However, every added core increases the cost of the solid-state drive.

The present invention is therefore intended to obviate or at least alleviate the problems encountered in the prior art.

### SUMMARY OF INVENTION

It is the primary objective of the present invention to provide an effective and inexpensive method for mitigating writing-performance variation and preventing IO blocking.

To achieve the foregoing objective, the method includes the steps of receiving a request, determining whether status of a SSD is normal or constrained, fulfilling the request if the status is normal, inserting the request in a queue if the status is constrained, monitoring a first request in the queue and calculating expected time of waiting, determining whether elapsed time of the first request is longer than or identical to the expected time of waiting, waiting for some time before returning to the step of monitoring the first request and calculating the expected time of waiting if the elapsed time is shorter than the expected time of waiting, fulfilling and removing the first request from the queue if the elapsed time is longer than or identical to the expected time of waiting, determining whether the queue is empty, returning to the step of waiting for some time if the queue is not empty, and ending if the queue is empty.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of a data storage apparatus such as solid-state drive that can execute a method for mitigating writing-performance variation and preventing IO blocking according to the preferred embodiment of the present invention;

FIG. 2 is a flow chart of the method for mitigating writing-performance variation and preventing IO blocking according to the preferred embodiment of the present invention;

FIG. 3 is a flow chart of a subroutine of the method shown in FIG. 2;

FIG. 4 is a flow chart of another subroutine of the method shown in FIG. 2; and

FIG. 5 is a flow chart of another subroutine of the method shown in FIG. 2.

### DETAILED DESCRIPTION OF PREFERRED EMBODIMENT

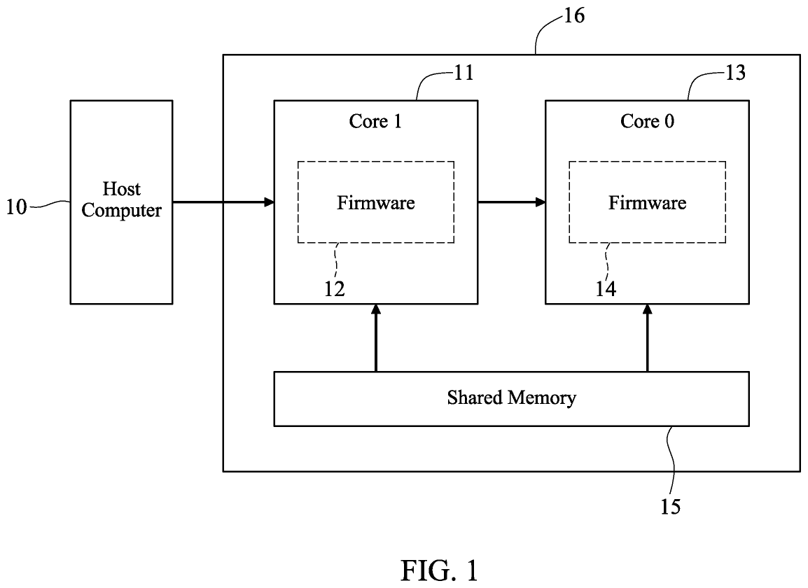

Referring to FIG. 1, a host 10 is connected to a solid-state drive controller 16. The solid-state drive controller 16 includes two central processor units 11 and 13 and a shared memory 15. In the industry, the central processor unit 11 is called “Core 1” and connected to the host 10, the central processor unit 13 is called “Core 0” and connected to the central processor unit 11. The memory 15 is connected to the central processor units 11 and 13.

In use, the central processor unit 11 runs firmware 12 to receive a request for writing (the “request”) from the host 10. The central processor unit 13 runs firmware 14 to receive from the central processor unit 11 the request. The central processor unit 13 provides two variables, i.e., “control flow” and “garbage collection efficiency.” These variables are stored in the memory 15. The control flow is given according to the status of the solid-state drive. The control flow includes two values, i.e., “normal” and “constrained.” “Garbage collection efficiency” is the amount of data recycled per unit of time. The solid-state drive controller 16 executes a method for mitigating writing-performance variation and preventing IO blocking according to the preferred embodiment of the present invention executable. The control flow and the garbage collection efficiency are used in the method for mitigating writing-performance variation and preventing IO blocking according to the preferred embodiment of the present invention.

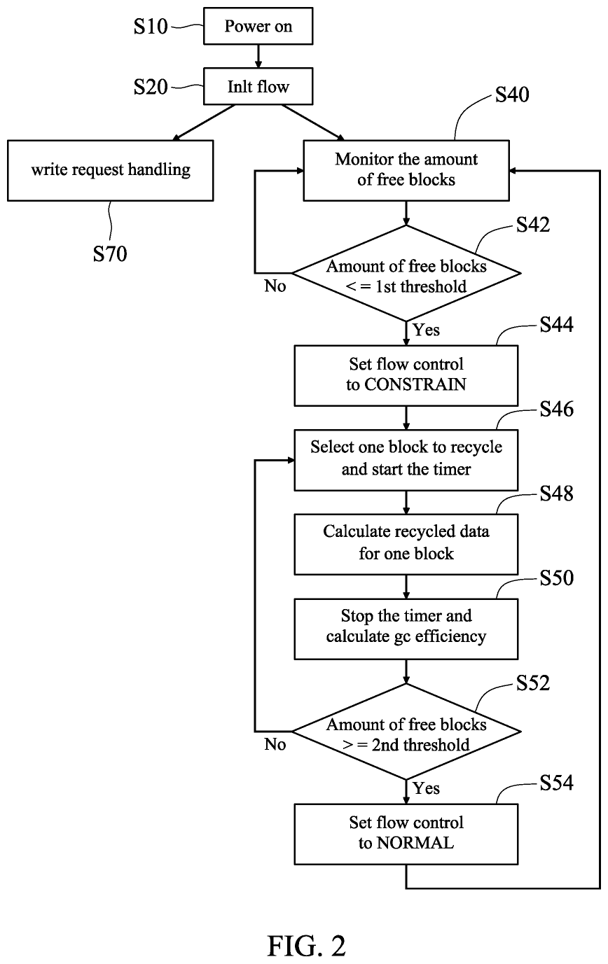

Referring to FIG. 2, shown is the method for mitigating writing-performance variation and preventing IO blocking according to the preferred embodiment of the present invention. At S10, the solid-state drive controller 16 is turned on. Then, the process goes to S20.

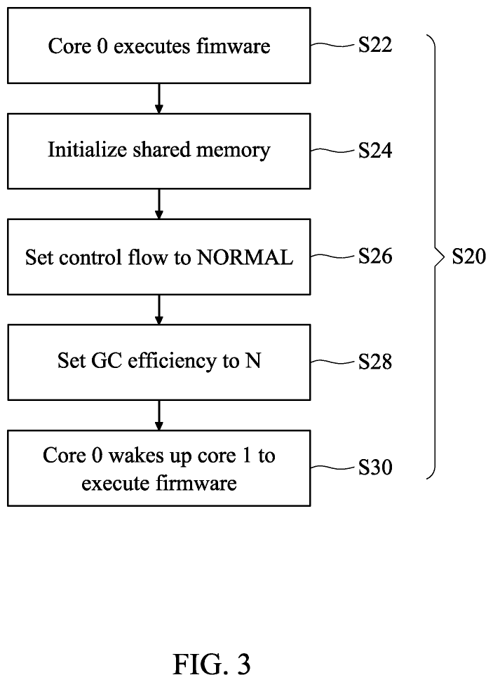

Referring to FIG. 3, S20 is an initializing process. In the initializing process, at S22, central processor unit 13 executes firmware 14. Then, the process goes to S24.

At S24, the memory 15 is initialized. Then, the process goes to S26.

At S26, the control flow is set to be normal. Then, the process goes to S28.

At S28, the garbage collection efficiency is set to be N. N is a default. Then, the process goes to S30.

At S30, the central processor unit 13 calls the central processor unit 11 to run the firmware 12. Then, the central processor unit 13 executes S40, and the central processor unit 11 executes S70 (FIG. 2).

Referring to FIG. 2, at S40, the central processor unit 13 monitors the amount of free blocks. Then, the process goes to S42.

At S42, it is determined whether the amount of the free blocks is smaller than or identical to a first threshold. The process goes to S44 to recycle garbage if the amount of the free blocks is smaller than or identical to the first threshold. The process returns to S40 if the amount of the free blocks is larger than the first threshold.

At S44, the control flow is set to be constrained. Now, the amount of the free blocks is smaller than the first threshold so that writing cannot be performed at a normal rate. Therefore, the control flow is set to be “constrained.” Then, the process goes to S46.

At S46, a block is selected for garbage collection, and a timer is started. Then, the process goes to S48. Such recycled blocks become free blocks.

At S48, the amount of the recycled garbage of the selected block is calculated. Then, the process goes to S50.

At S50, the timer is stopped, and the garbage collection efficiency is calculated and stored in the memory 15. The garbage collection efficiency is calculated by dividing the amount of the recycled garbage by the time recorded by the timer. Then, the process goes to S52.

At S52, it is determined whether the amount of the free blocks is larger than or identical to a second threshold. The process returns to S46 if the amount of the free blocks is smaller than the second threshold. The process goes to S54 if the amount of the free blocks is larger than or identical to the second threshold. The second threshold should be properly larger than the first threshold, or the garbage collection would be executed in many rounds and each round of the garbage collection would last for a very short period of time.

At S54, the control flow is set to be “normal.” Then, the process returns to S40.

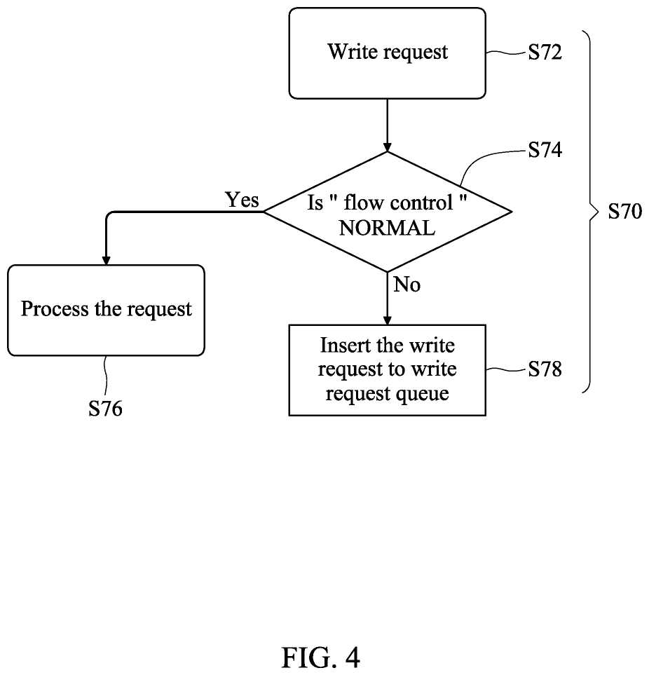

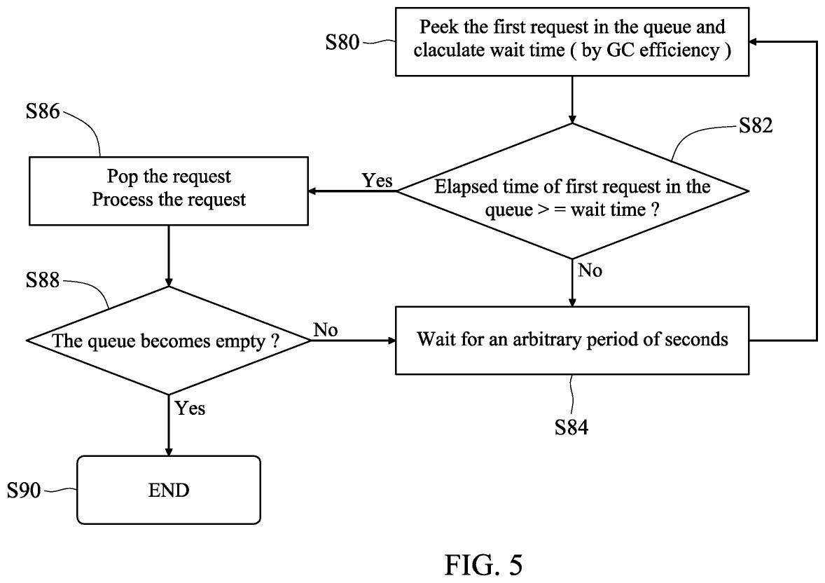

Referring to FIGS. 4 and 5, S70 represents another subroutine. At S70, the central processor unit 11 handles the request.

At S72, the central processor unit 11 receives from the host 10 the request. Then, the process goes to S74.

At S74, it is determined whether the control flow is normal. The process goes to S76 if so, and goes to S78 if otherwise.

S76, the request is handled. In specific, the central processor unit 11 sends the request to the central processor unit 13. Then, the central processor unit 13 handles the request.

At S78, the request is inserted in a queue. That is, the request is arranged after previous requests for writing to be handled. Then, the process goes to S80.

At S80, the first request in the queue is monitored, and expected time of waiting is calculated. The so called “expected time of waiting” is a calculated period of time for which the first request is expected to wait before data is written in the data storage apparatus according to the first request. To calculate the expected time of waiting, the central processor unit 11 reads the garbage collection efficiency from the memory 15, and divides the amount of the data of the first request by the garbage collection efficiency. Then, the process goes to S82.

At S82, it is determined whether elapsed time is longer than or identical to the expected time of waiting. The “elapsed time” is the time for which the first request has been in the queue. The elapsed is measured from the point of time at which the central processor unit 11 begins to monitor the first request. The process goes to S86 if so, and the process goes to S84 if otherwise.

At S84, the system waits for a proper period of time such as several seconds. Then, the process returns to S80.

At S86, the first request is fulfilled and removed from the queue. To fulfill the first request, the central processor unit 11 sends the first request to the central processor unit 13. Then, then central processor unit 13 stores data in the data storage apparatus according to the first request. Then, the process goes to S88.

At S88, it is determined whether the queue is empty. The process goes to S90 if so, and returns to S84 if otherwise.

At S90, the process ends.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A method for mitigating writing performance variation and preventing IO blocking, the method comprising the steps of:
receiving a request for writing (S72);
determining whether status of a solid-state drive is normal or constrained (S74);
fulfilling the request if the status is normal (S76);
inserting the request in a queue if the status is constrained (S78);
monitoring a first request in the queue and calculating expected time of waiting (S80);
determining whether elapsed time of the first request is longer than or identical to the expected time of waiting (S82);
waiting for a period of time before returning to the step of monitoring the first request in the queue and calculating the expected time of waiting (S80) if the elapsed time is shorter than the expected time of waiting (S84);
fulfilling the first request and removing the first request from the queue if the elapsed time is longer than or identical to the expected time of waiting (S86);
determining whether the queue is empty (S88);
returning to the step of waiting for a period of time (S84) if the queue is not empty; and
ending if the queue is empty.

2. The method according to claim 1, further comprising the steps of:
setting the status of the solid-state drive to be normal (S26) before the step of receiving a request (S72); and
setting the status of the solid-state drive to be normal or constrained after or at the same as the step of receiving a request (S72).

3. The method according to claim 2, wherein the step of setting the status of the solid-state drive to be normal or normal or constrained comprises the steps of:
monitoring the amount of the free blocks (S40);
determining whether the amount of the free blocks is smaller than or identical to a first threshold (S42);
setting the status of the solid-state drive to be constrained if the amount of the free blocks is smaller than or identical to the first threshold (S44); and
returning to the step of monitoring the amount of the free blocks (S40) if the amount of the free blocks is larger than the first threshold.

4. The method according to claim 3, wherein the step of setting the status of the solid-state drive to be constrained (S44) comprises the steps of:
recycling a block so that it becomes a free block (S46);
calculating the amount of the recycled blocks (S48); and
determining whether the amount of the free blocks is larger than or identical to a second threshold (S52);
returning to the step of recycling a block (S46) if the amount of the free blocks is smaller the second threshold; and
setting the status of the solid-state drive to be normal (S54) if the amount of the free blocks is larger than or identical to the second threshold.

5. The method according to claim 4, wherein the second threshold is larger than or identical to the first threshold.

6. The method according to claim 4, after the step of setting the status of the solid-state drive to be constrained (S44), further comprising the step of calculating garbage collection efficiency (S50).

7. The method according to claim 6, before the step of calculating garbage collection efficiency, further comprising the steps of:
starting a timer after the step of recycling a block (S46); and
calculating amount of the recycled garbage (S48) after the step of recycling a block (S46).

8. The method according to claim 7, wherein the step of calculating the garbage collection efficiency (S48) comprises the step of dividing the amount of the recycled garbage by the time recorded by the timer.
